(19) United States
(12) Patent Application Publication
(10) Pub. No.: US 2015/0365517 A1
(43) Pub. Date: Dec. 17, 2015

(54) Method and System for Raising Fund Using Mobile Lock Screen And Social Groups Associated Thereof

(71) Applicant: Jian Wei Tam, New York, NY (US)

(72) Inventor: Jian Wei Tam, New York, NY (US)

(21) Appl. No.: 14/301,412

(22) Filed: Jun. 11, 2014

(51) Int. Cl. H04M 1/725; G06Q 50/00; G06Q 30/02; G06Q 20/10; G06Q 20/32

(52) U.S. Cl. CPC H04M 1/72583; G06Q 20/10; G06Q 20/3223; G06Q 30/0279; G06Q 50/01

(57) ABSTRACT

A method and system for raising fund using mobile lock screen and social groups associated thereof. Particularly, the application provides a method and system for raising fund using lock screen of a user's mobile communication device and social groups associated thereof using a mobile lock screen application.

### FIELD OF THE INVENTION

The present application generally relates to the field of mobile applications. Particularly, the application provides a method and system for raising fund using lock screen of a user's mobile communication device and social groups associated thereof using a mobile lock screen application.

### BACKGROUND

The mobile communication devices facilitate human interactions. Apart from basic communication services, every mobile communication device provides user with a lock screen space. The mobile lock screen enables the user to communicate with other user for various purposes with eliminating the need of unlocking the mobile communication device. With the incremental uses of mobile lock screen space, various applications have been developed for the mobile communication device's lock screen.

Prior art literature illustrates a variety of mobile applications for lock screen of mobile communication devices. However, the lock screen space of the mobile communication device is still missing a fund raising mechanism wherein funding can be raise using social groups associated with said mobile lock screen. Prior art doesn't discloses any such mobile lock screen applications, which could help mobile lock screen users to explore opportunities to raise fund and for other users to donate or invest by way of lending by bringing the highly relevant and curated options on their mobile lock screen space.

Thus prior art solutions fail to facilitate social funding or crowd funding for needful users via lock screen of the mobile communication device. Prior art solutions also fail to eliminate need of exploring other funding platforms or websites for fund raising.

Thus, in the light of the above mentioned background art, it is evident that, there is a need for a mechanism wherein a user is enabled to raise funds using social groups that are associated with mobile lock screen. A method and system is desired for raising fund using lock screen of a user's mobile communication device and social groups associated thereof using a mobile lock screen application.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for raising fund using lock screen of a user's mobile communication device and social groups associated thereof using a mobile lock screen application.

In an embodiment of the present invention, a method for raising fund using lock screen of a user's mobile communication device and social groups associated thereof using a mobile lock screen application is provided; said method comprises of pushing relevant digital content by at least one fund raising user on a plurality of fund contributing user's mobile communication device's lock screen; receiving said relevant digital content by the plurality of fund contributing users on their mobile communication device's lock screen, pushed by at least one fund raising user; swiping a fund raising application icon on mobile communication device's lock screen by the plurality of fund contributing users upon receiving said relevant digital content pushed by at least one fund raising user; and transferring a credit from the plurality of fund contributing users to at least one fund raising user.

The above said method and system is provided for raising fund using lock screen of a user's mobile communication device and social groups associated thereof using a mobile lock screen application but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a flow chart illustrating method for raising fund using lock screen of a user's mobile communication device and social groups associated thereof using a mobile lock screen application.

FIG. 2: shows a flow chart illustrating method for listing of the plurality of fund contributing users along with transferred credit to at least one fund raising user.

FIG. 3: shows a flow chart illustrating method for updating the plurality of fund contributing users with cumulative transferred credit to at least one fund raising user.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

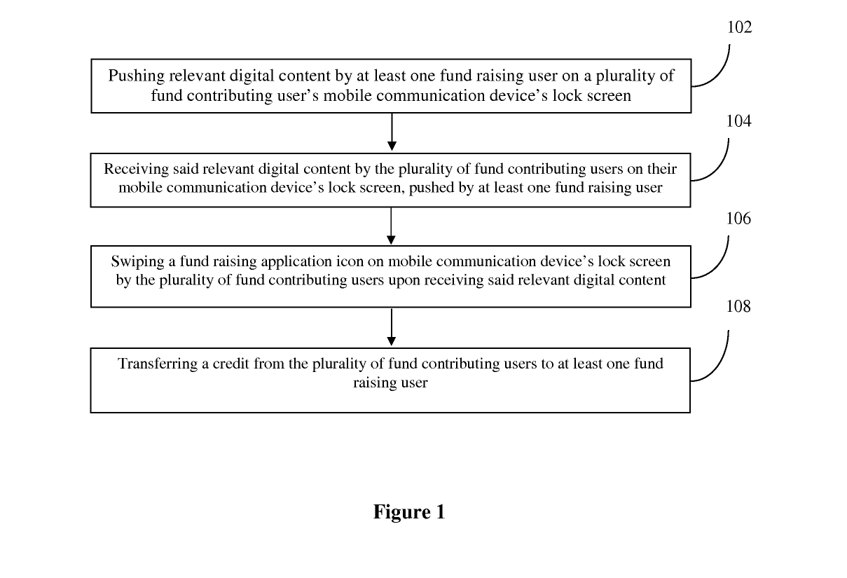

Referring to FIG. 1 is a flow chart illustrating method for raising fund using lock screen of a user's mobile communication device and social groups associated thereof using a mobile lock screen application.

The process starts at the step 102, a relevant digital content is pushed by at least one fund raising user on a plurality of fund contributing user's mobile communication device's lock screen.

In an embodiment of the present invention, a system is provided for raising fund using lock screen of a user's mobile communication device and social groups associated thereof using a mobile lock screen application. The system comprises of a mobile lock screen application residing in a mobile communication device for raising fund using lock screen of a user's mobile communication device and social groups associated thereof, wherein the mobile communication device is selected from a group comprising but not limited to mobile phone, laptop, and PDA.

In another embodiment of the present invention, a method and system is provided for raising fund using lock screen of a user's mobile communication device and social groups associated thereof using a mobile lock screen application, wherein said relevant digital content is pushed by at least one fund raising user on the plurality of fund contributing user's mobile communication device's lock screen which are associated with at least one fund raising user over social groups associated with lock screen mobile communication device.

In another embodiment of the present invention, the digital content pushed by at least one fund raising user on the plurality of fund contributing user's mobile communication device's lock screen is selected from a group comprising of fund raising campaigns and fund raising stories. The fund raising campaigns and fund raising stories further comprises a multimedia content selected from a group comprising of text, image, audio and video, wherein said image associated with fund raising campaigns and fund raising stories is a full lock screen image.

At the step 104, said relevant digital content is received by the plurality of fund contributing users on their mobile communication device's lock screen, pushed by at least one fund raising user.

In another embodiment of the present invention, wherein said digital content is received by a plurality of fund contributing users on their mobile communication device's lock screen, pushed by at least one fund raising user according to categorized user preference and user interests selected by said plurality of fund contributing users.

At the step 106, a fund raising application icon is swiped on mobile communication device's lock screen by the plurality of fund contributing users upon receiving said relevant digital content pushed by at least one fund raising user.

In another embodiment of the present invention, wherein said fund raising application icon swiped by a plurality of fund contributing users on their mobile communication device's lock screen is corresponding to said received relevant digital content pushed by at least one fund raising user.

In another embodiment of the present invention, said fund raising further comprises of mode of funding selected from a group comprising of donation and lending. The plurality of fund contributing users are enabled to select the option of donation or lending upon swiping said fund raising application icon on mobile communication device's lock screen, upon receiving said relevant digital content pushed by at least one fund raising user. The lending option selected by the plurality of fund contributing users is further provided with a plurality of repayment options.

The process ends at the step 108, a credit is transferred from the plurality of fund contributing users to at least one fund raising user.

In another embodiment of the present invention, wherein the credit transferred from a plurality of fund contributing users to at least one fund raising user is selected from a group comprising of credit earned from using said lock screen application and added into said lock screen application as a pre-load or credit card.

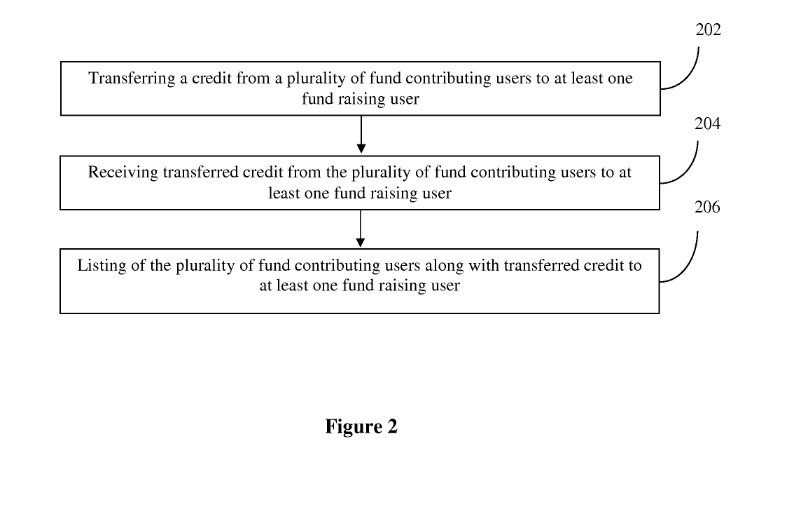

Referring to FIG. 2 is a flow chart illustrating method for listing of the plurality of fund contributing users along with transferred credit to at least one fund raising user.

The process starts at the step 202, a credit is transferred from a plurality of fund contributing users to at least one fund raising user. At the step 204, the transferred credit is received from the plurality of fund contributing users to at least one fund raising user. The process ends at the step 206, the plurality of fund contributing users are listed along with transferred credit to at least one fund raising user.

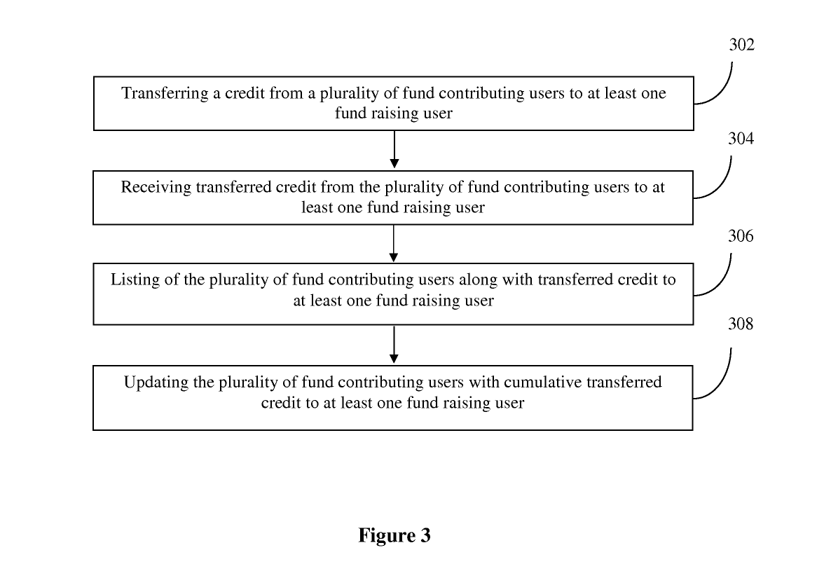

Referring to FIG. 3 is a flow chart illustrating method for updating the plurality of fund contributing users with cumulative transferred credit to at least one fund raising user.

The process starts at the step 302, a credit is transferred from a plurality of fund contributing users to at least one fund raising user. At the step 304, the transferred credit is received from the plurality of fund contributing users to at least one fund raising user. At the step 306, the plurality of fund contributing users are listed along with transferred credit to at least one fund raising user. The process ends at the step 308, the plurality of fund contributing users are updated with cumulative transferred credit to at least one fund raising user.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1) A method for raising fund using lock screen of a user's mobile communication device and social groups associated thereof using a mobile lock screen application; said method comprises of:
a. pushing relevant digital content by at least one fund raising user on a plurality of fund contributing user's mobile communication device's lock screen;
b. receiving said relevant digital content by the plurality of fund contributing users on their mobile communication device's lock screen, pushed by at least one fund raising user;
c. swiping a fund raising application icon on mobile communication device's lock screen by the plurality of fund contributing users upon receiving said relevant digital content pushed by at least one fund raising user; and
d. transferring a credit from the plurality of fund contributing users to at least one fund raising user.

2) The method as claimed in claim 1, wherein said fund raising further comprises of mode of funding selected from a group comprising of donation and lending.

3) The method as claimed in claim 1, wherein said lending option further comprises of the plurality of repayment options.

4) The method as claimed in claim 1, wherein said relevant digital content is pushed by at least one fund raising user on the plurality of fund contributing user's mobile communication device's lock screen which are associated with at least one fund raising user over social groups associated with lock screen mobile communication device.

5) The method as claimed in claim 1, wherein said digital content is selected from a group comprising of fund raising campaigns and fund raising stories.

6) The method as claimed in claim 5, wherein said fund raising campaigns and fund raising stories further comprises a multimedia content selected from a group comprising of text, image, audio and video.

7) The method as claimed in claim 6, wherein said image associated with fund raising campaigns and fund raising stories is a full lock screen image.

8) The method as claimed in claim 1, wherein said digital content is received by the plurality of fund contributing users on their mobile communication device's lock screen, pushed by at least one fund raising user according to categorized user preference and user interests selected by said plurality of fund contributing users.

9) The method as claimed in claim 1, wherein said fund raising application icon swiped by the plurality of fund contributing users on their mobile communication device's lock screen is corresponding to said received relevant digital content pushed by at least one fund raising user.

10) The method as claimed in claim 1, wherein the credit transferred from the plurality of fund contributing users to at least one fund raising user is selected from a group comprising of credit earned from using said lock screen application and added into said lock screen application as a pre-load or credit card.

11) The method as claimed in claim 1, further comprises of listing of the plurality of fund contributing users along with transferred credit to at least one fund raising user.

12) The method as claimed in claim 1, further comprises of updating the plurality of fund contributing users with cumulative transferred credit to at least one fund raising user.

13) A system for raising fund using lock screen of a user's mobile communication device and social groups associated thereof using a mobile lock screen application; said system comprises of a mobile lock screen application residing in a mobile communication device for raising fund using lock screen of a user's mobile communication device and social groups associated thereof, wherein the mobile communication device is selected from a group comprising but not limited to mobile phone, laptop, and PDA.
